(19) United States
(12) Patent Application Publication
(10) Pub. No.: US 2025/0106169 A1
(43) Pub. Date: Mar. 27, 2025

(54) DROPPING APPLICATION DATA UNITS

(71) Applicant: Lenovo (Singapore) Pte. Limited, Singapore (SG)

(72) Inventors: Hossein Bagheri, Urbana, IL (US); Razvan-Andrei Stoica, Essen (DE); Vijay Nangia, Woodridge, IL (US)

(73) Assignee: Lenovo (Singapore) Pte. Limited, Singapore (SG)

(21) Appl. No.: 18/730,509

(22) PCT Filed: Jan. 19, 2023
(86) PCT No.: PCT/IB2023/050469

§ 371 Date: Jul. 19, 2024

Related U.S. Application Data
(60) Provisional application No. 63/300,766, filed on Jan. 19, 2022.

(51) Int. Cl. H04L 47/32; H04W 28/02

(52) U.S. Cl. CPC H04L 47/323; H04W 28/0289

(57) ABSTRACT

Various aspects of the present disclosure relate to a user equipment (UE) that receives scheduling information for a set of physical downlink shared channel (PDSCH) transmissions. The UE also receives downlink control information (DCI) comprising an indication to discard processing of a subset of PDSCH transmissions of the set of PDSCH transmissions, the DCI received prior to a first PDSCH transmission of the subset of the PDSCH transmissions. The UE can discard processing of the subset of the PDSCH transmissions based at least in part on the received DCI indication. For example, to discard the processing of the subset of the PDSCH transmissions, the UE can terminate hybrid automatic repeat request acknowledgement (HARQ-ACK) operations, or skip forward error correction operations associated with the subset of the PDSCH transmissions, or both.

### RELATED APPLICATION

This application claims priority to U.S. Patent Application Ser. No. 63/300,766 filed Jan. 19, 2022 entitled “Dropping Application Data Units,” the disclosure of which is incorporated by reference herein in its entirety.

### TECHNICAL FIELD

The present disclosure relates to wireless communications, and more specifically to dropping application data units, such as for extended reality (XR) services.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

Overall, the term extended reality (XR) is meant to encompass different types of digitally-enhanced realities, including virtual reality (VR), augmented reality (AR), and mixed reality (MR). The XR refers to and includes all real and virtual combined environments, as well as human-machine interactions generated by computer technology and wearables. The XR includes the representative forms of VR, AR, and MR, as well as the areas interpolated among them. The levels of virtuality range from partial sensory inputs to fully immersive VR. A key aspect of XR is the extension of human experiences, particularly relating to the senses of existence, as represented by VR, and the acquisition of cognition, as represented by AR.

Virtual reality (VR) is a rendered version of a delivered visual and audio scene. The rendering is designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated in order to ensure that, from the user's perspective, items and sound sources remain consistent with the user's movements. Additional means to interact with the virtual reality simulation may be provided.

Augmented reality (AR) is when a user is provided with additional information or artificially generated items or content overlaid upon their current environment. Such additional information or content will usually be visual and/or audible and their observation of the current environment may be direct, with no intermediate sensing, processing, and rendering, or indirect, where the perception of the environment is relayed via sensors and may be enhanced or processed. Mixed reality (MR) is an advanced form of AR where some virtual elements are inserted into the physical scene with the intent to provide the illusion that these elements are part of the real scene.

### SUMMARY

The present disclosure relates to methods, apparatuses, and systems that support dropping application data units, such as for extended reality (XR) service, which encompasses different types of digitally-enhanced realities, including virtual reality (VR), augmented reality (AR), and mixed reality (MR). The XR refers to and includes all real and virtual combined environments, as well as human-machine interactions generated by computer technology and wearables. By utilizing the described techniques, a UE can discard, stop, and/or skip the processing and generating a set of scheduled transmissions in response to a negative acknowledgment (NACK) corresponding to one or more elements of the set of scheduled transmissions, or in response to a downlink control information (DCI) indication, where the set of scheduled transmissions correspond to a media unit with packet data units (PDUs) having the same quality of service (QoS) characteristics as PDUs belonging to the same application data unit (ADU). Aspects of the described techniques can be implemented to enhance a downlink interruption indication and/or an uplink cancellation indication to facilitate dropping packets corresponding to the same ADU.

Many types of XR and cloud gaming (CG) use cases are characterized by quasi-periodic traffic, with possible jitter, given the high data rate in a downlink video stream combined with the frequent uplink updates, such as for user pose and control updates, and the uplink video stream. Both the downlink and the uplink data traffic are also characterized by a relatively strict packet delay budget (PDB). The set of anticipated XR and CG services poses a variety or characteristics of the data uplink and downlink video streams, and may change “on-the-fly” while the services are running over NR. Therefore, additional information on the running services from higher layers, such as the quality of service (QoS) flow association, frame-level QoS, application data unit (ADU)-based QoS, XR specific QoS, etc., can be utilized and is beneficial to facilitate informed choices of radio parameters. Notably, the XR application awareness by both a UE and gNB would improve the user experience, improve the NR system capacity in supporting XR services, and reduce the UE power consumption. The described techniques also provide that the network (e.g., a base station, gNB) can schedule other UEs or other data traffic for the same UE, which has had some of its packets discarded, given the time, frequency, and/or spatial resources associated with the discarded packets, hence increasing system capacity.

Some implementations of the method and apparatuses described herein may include an apparatus (e.g., a UE), which receives scheduling information for a set of physical downlink shared channel (PDSCH) transmissions from a base station (e.g., a gNB, the network). The UE also receives downlink control information (DCI) comprising an indication to discard processing of a subset of PDSCH transmissions of the set of PDSCH transmissions, where the DCI is received prior to a first PDSCH transmission of the subset of the PDSCH transmissions. The UE discards processing of the subset of the PDSCH transmissions based at least in part on the DCI.

In some implementations of the method and apparatuses described herein, the subset of the PDSCH transmissions includes one or more PDSCHs that scheduled after at least a second PDSCH. The UE can generate a negative acknowledgment (NACK) based at least in part on receiving the second PDSCH transmission of the set of PDSCH transmissions, and the UE transmits the NACK to the base station. The UE can discard the processing of the subset of the PDSCH transmissions by terminating hybrid automatic repeat request acknowledgement (HARQ-ACK) operations, and/or by skipping forward error correction operations associated with the subset of the PDSCH transmissions. Additionally, the UE can transmit a HARQ-ACK associated with a PDSCH transmission of the subset of the PDSCH transmissions based at least in part on a respective DCI associated with the PDSCH transmission of the subset of the PDSCH transmissions, and/or based on an indication indicting whether the PDSCH of the subset of the PDSCH transmissions is associated with an intra-frame (I-frame).

The UE may discontinuously monitor a physical downlink control channel (PDCCH) during an active duration for a serving cell; and reduce the active duration by a value based at least in part on the indication to discard the processing of the subset of PDSCH transmissions. The value can be determined based at least in part on a time that a HARQ-ACK corresponding to a PDSCH of the subset of PDSCH transmissions is transmitted, and/or based at least in part on a pending duration remaining until an expiration of the active duration. The DCI comprising the indication to discard the subset of PDSCH transmissions may be received as the DCI at or an amount of time after the HARQ-ACK corresponding to the PDSCH transmission of the subset of PDSCH transmissions is transmitted. The subset of the PDSCH transmissions can include one or more PDSCHs corresponding to packet data units (PDUs) of a same application data unit (ADU). The UE can also determine a period that a packet delay budget (PDB) associated with a HARQ operation exceeds a PDB threshold, and transmit, to a base station, information indicating the determined period that the PDB associated with the HARQ operation exceeds the PDB threshold. The UE can determine a time duration for receiving the indication to discard the processing of the subset of PDSCH transmissions, where to receive the DCI comprising the indication to discard the processing of the subset of PDSCH transmissions occurs during the time duration, the time duration occurring after the information is transmitted indicating the determined period that the PDB associated with the HARQ operation exceeds the PDB threshold. The indication to discard the processing of the subset of PDSCH transmissions is received by the UE in a DCI format used for scheduling a physical uplink shared channel (PUSCH) or a PDSCH, or both. The indication to discard the processing of the subset of PDSCH transmissions can indicate a PDSCH group index, and the subset of the PDSCH transmissions are scheduled with the same PDSCH group index.

Some implementations of the method and apparatuses described herein may include an apparatus (e.g., a base station, gNB), which transmits scheduling information to a UE for a set of PDSCH transmissions. The base station also transmits DCI comprising an indication to discard processing of a subset of PDSCH transmissions of the set of PDSCH transmissions, where the DCI is received by the UE prior to a first PDSCH transmission of the subset of the PDSCH transmissions. The base station can also receive a NACK from the UE in response to the UE receiving at least a second PDSCH transmission of the set of PDSCH transmissions, and the subset of the PDSCH transmissions includes one or more PDSCHs that scheduled after the at least second PDSCH.

### BRIEF DESCRIPTION OF THE DRAWINGS

Various aspects of the present disclosure for dropping application data units are described with reference to the following Figures. The same numbers may be used throughout to reference like features and components shown in the Figures.

FIG. 1 illustrates an example of a wireless communications system that supports dropping application data units in accordance with aspects of the present disclosure.

FIGS. 2, 3, and 4 illustrate example scenarios that support dropping application data units in accordance with aspects of the present disclosure.

FIG. 5 illustrates an example of gNB uplink scheduled transmissions that supports dropping application data units in accordance with aspects of the present disclosure.

FIGS. 6 and 7 illustrate examples of an extended DRX cycle during the on-duration or active time that supports dropping application data units in accordance with aspects of the present disclosure.

FIG. 8 illustrates an example block diagram of components of a device (e.g., a UE) that supports dropping application data units in accordance with aspects of the present disclosure.

FIG. 9 illustrates an example block diagram of components of a device (e.g., a base station, a gNB) that supports dropping application data units in accordance with aspects of the present disclosure.

FIGS. 10, 11, and 12 illustrate flowcharts of methods that support dropping application data units in accordance with aspects of the present disclosure.

### DETAILED DESCRIPTION

Implementations of dropping application data units are described, such as related to extended reality service. Overall, extended reality (XR) encompass different types of digitally-enhanced realities, including virtual reality (VR), augmented reality (AR), and mixed reality (MR). The XR refers to and includes all real and virtual combined environments, as well as human-machine interactions generated by computer technology and wearables. The XR includes the representative forms of VR, AR, and MR, as well as the areas interpolated among them. The levels of virtuality range from partial sensory inputs to fully immersive VR. A key aspect of XR is the extension of human experiences, particularly relating to the senses of existence, as represented by VR, and the acquisition of cognition, as represented by AR.

Many types of XR and cloud gaming (CG) use cases are characterized by quasi-periodic traffic, with possible jitter, given the high data rate in the downlink video stream combined with the frequent uplink updates, such as for user pose and control updates, and/or the uplink video stream. Both the downlink and the uplink data traffic are also characterized by a relatively strict packet delay budget (PDB). The set of anticipated XR and CG services poses a variety or characteristics of the data uplink and downlink video streams, and may change “on-the-fly” while the services are running over NR. Therefore, additional information on the running services from higher layers, such as the quality of service (QoS) flow association, frame-level QoS, application data unit (ADU)-based QoS, XR specific QoS, etc., can be utilized and is beneficial to facilitate informed choices of radio parameters. Notably, the XR application awareness by both a UE and gNB would improve the user experience, improve the NR system capacity in supporting XR services, and reduce the UE power consumption.

Data packets within a frame may have dependency on or with each other since an application running on a UE typically needs all of these packets for decoding the frame. Hence one packet loss will render the other correlative packets useless even if they are successfully transmitted. For example, XR applications impose requirements in terms of media units (e.g., application data units (ADU)), rather than in terms of single packets or packet data units (PDUs). An ADU is the smallest unit of data processed independently by an application, such as processing for handling out-of-order traffic data (e.g., out of order ADU handling). In addition to ADUs, other media units, such as video and/or audio frames or video/picture subdivided into slices or tiles, and control information, can be used, where media units consist of PDUs that have the same QoS requirements. Further, data packets of a same video stream, having different frame types (I, B, and P frames), or even different positions in the group of picture (GoP), provide different contributions to user experience in XR applications, and so a layered QoS handling within the video stream can potentially relax the requirement and thus lead to higher efficiency.

Aspects of the techniques for dropping application data units takes into account XR data traffic characteristics, which can include variable packet arrival rate, with packets being received at 30-120 frames-per-second with some jitter, packets having variable and large packet sizes, B/P-frame types being dependent on I-frames, and the presence of multiple data traffic and data flows, such as pose and video scenes in uplink transmissions. Packets of a video frame or a video stream may be dependent on each other, and if a subset of the packets cannot be received on time, such as due to retransmission attempts, the rest of the pending packets may not be useful. For a radio access network (RAN) scheduler that estimates or determines scheduled packet dependencies, this disclosure provides techniques to discard already scheduled packets that may not be useful when received. The described techniques enable a more efficient XR service delivery in terms of satisfying XR service requirements for a greater number of UEs, or in terms of UE power saving. The described techniques also provide that the network (e.g., a base station, gNB) can schedule other UEs or other data traffic for the same UE, which has had some of its packets discarded, given the time, frequency, and/or spatial resources associated with the discarded packets, hence increasing system capacity. Other benefits include saving device power for the UE by not processing packets that are or will not be useful.

Aspects of the present disclosure are described in the context of a wireless communications system. Aspects of the present disclosure are further illustrated and described with reference to device diagrams and flowcharts that relate to dropping application data units.

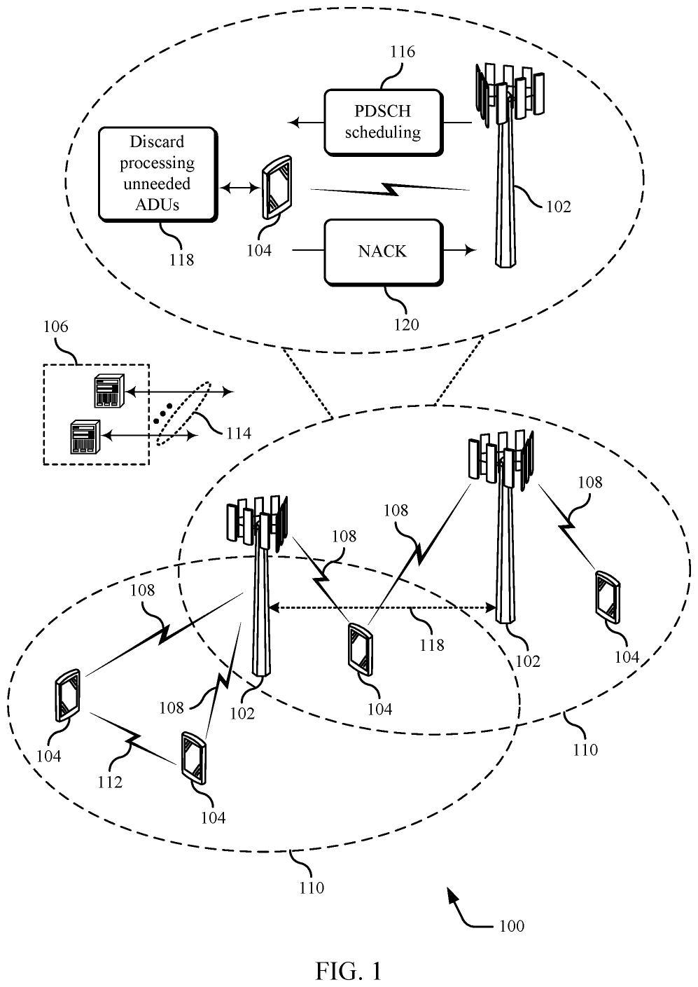

FIG. 1 illustrates an example of a wireless communications system 100 that supports dropping application data units in accordance with aspects of the present disclosure. The wireless communications system 100 may include one or more base stations 102, one or more UEs 104, a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 118 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as a radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations, one or more of the UEs 104 and base stations 102 are operable to implement various aspects of dropping application data units, as described herein. For instance, a base station 102 can communicate PDSCH scheduling assignments 116 and DCI for a set of PDSCH transmissions to a UE 104. The UE 104 receives the PDSCH scheduling assignments 116 and DCI, and can discard processing unneeded ADUs 118 from the set of PDSCH transmissions responsive to the DCI. The UE 104 can also generate and transmit a NACK back to the base station 102. The UE can discard processing the unneeded ADUs 118 from the set of PDSCH transmissions responsive to the NACK.

Many types of XR and cloud gaming (CG) use cases are characterized by quasi-periodic traffic, with possible jitter, given the high data rate in the downlink video stream combined with the frequent uplink updates, such as for user pose and control updates, and/or the uplink video stream. Both the downlink and the uplink data traffic are also characterized by a relatively strict packet delay budget (PDB). The set of anticipated XR and CG services poses a variety or characteristics of the data uplink and downlink video streams, and may change “on-the-fly” while the services are running over NR. Therefore, additional information on the running services from higher layers, such as the quality of service (QoS) flow association, frame-level QoS, application data unit (ADU)-based QoS, XR specific QoS, etc., can be utilized and is beneficial to facilitate informed choices of radio parameters. Notably, the XR application awareness by both a UE and gNB would improve the user experience, improve the NR system capacity in supporting XR services, and reduce the UE power consumption.

Data packets within a frame may have dependency on or with each other since an application running on a UE typically needs all of these packets for decoding the frame. Hence one packet loss will render the other correlative packets useless even if they are successfully transmitted. For example, XR applications impose requirements in terms of media units (e.g., application data units (ADU)), rather than in terms of single packets or packet data units (PDUs). An ADU is the smallest unit of data processed independently by an application, such as processing for handling out-of-order traffic data (e.g., out of order ADU handling). In addition to ADUs, other media units, such as video and/or audio frames or/tiles, and control information, can be used, where media units consist of PDUs that have the same QoS requirements. Further, data packets of a same video stream, having different frame types (I, B, and P frames), or even different positions in the group of picture (GoP), provide different contributions to user experience in XR applications, and so a layered QoS handling within the video stream can potentially relax the requirement and thus lead to higher efficiency.

Aspects of the techniques for dropping application data units takes into account XR data traffic characteristics, which can include variable packet arrival rate, with packets being received at 30-120 frames-per-second with some jitter, packets having variable and large packet sizes, B/P-frame types being dependent on I-frames, and the presence of multiple data traffic and data flows, such as pose and video scenes in uplink transmissions. Packets of a video frame or a video stream may be dependent on each other, and if a subset of the packets cannot be received on time, such as due to retransmission attempts, the rest of the pending packets may not be useful. For a radio access network (RAN) scheduler that estimates or determines scheduled packet dependencies, this disclosure provides techniques to discard already scheduled packets that may not be useful when received. The described techniques enable a more efficient XR service delivery in terms of satisfying XR service requirements for a greater number of UEs, or in terms of UE power saving. The described techniques also provide that the network (e.g., a base station, gNB) can schedule other UEs or other data traffic for the same UE, which has had some of its packets discarded, given the time, frequency, and/or spatial resources associated with the discarded packets, hence increasing system capacity. Other benefits include saving device power for the UE by not processing packets that are or will not be useful.

With reference to packet delay budget (PDB), the latency requirement of XR traffic in RAN side (i.e., air interface) is modeled as PDB, which is a limited time budget for a packet to be transmitted over the air from a gNB to a UE. For a given packet, the delay of the packet incurred in air interface is measured from the time that the packet arrives at the gNB to the time that it is successfully transferred to the UE. If the delay is longer than a given PDB for the packet, then the packet is said to violate PDB, otherwise the packet is said to be successfully delivered. The value of PDB may vary for different applications and different data traffic types. For a delay labeling approach, a PDB associated with a packet could be indicated along with the packet being transmitted as the packet traverses throughout different processing, transmission blocks, and layers. Having the delay budget may facilitate implementations for dropping or de-prioritizing a packet for which the delay budget is exceeded. Described techniques of this disclosure can similarly be implemented with the delay labeling approach. This disclosure also provides the subsequent actions or operations once an already scheduled packet or a received packet is determined to be dropped or de-prioritized due to exceeding the delay budget.

For XR error concealment, a scheduler that estimates or determines a packet delay can determine if a packet is going to exceed its delay budget. Upon such determination, the gNB or RAN node can trigger an early or timely request for error concealment action from a server. For example, the gNB can request an I-frame on behalf of a client application running on the UE to shorten the I-frame reception time. The RAN triggering error concealment action(s) may be used along with, or in parallel to, the techniques proposed in this disclosure. For instance, if a gNB requests an I-frame on behalf of the client application running on the UE in response to determining that a packet is going to exceed its delay budget, the gNB can wait for a certain time duration, and then if the I-frame can be transmitted on time, the gNB would not send the discarding DCI; otherwise, the gNB would send the discarding DCI. In implementations, discarding a DCI can include discarding all of the commands provided by the DCI, or discarding a subset of the commands provided by the DCI. In an implementation, the UE can be indicated via a DCI scheduling a PDSCH for a maximum number of remaining retransmissions, or whether there is a possibility of a future retransmission associated with the PDSCH (considering the PDB), which can facilitate the UE determining when to use the error concealment feature.

Some downlink video packets may be received earlier than their expected or scheduled time, considering that video traffic has quasi-periodic packet arrivals, where packets are expected to occur at periodic instances subject to variation due to jitter. For the downlink video packets that may be received earlier than their expected or scheduled time, as compared to the packets that are received later than their expected or scheduled time, the earlier packets can be delayed in scheduling, or can be transmitted over a longer duration or with more HARQ retransmissions, if needed, which may facilitate system capacity improvement. This aspect may provide for calculating an adaptive PDB for a packet or group of packets considering the jitter, and the techniques introduced in this disclosure can be implemented along with adaptive PDB.

Relevant packets belonging to an ADU and already arrived in RAN may not be used for rendering and can be dropped in the instance when an IP packet belonging to the ADU is too late, which may facilitate to increase system capacity compared to the case when those packets get transmitted. For example, the group packet data convergence protocol (PDCP) dropping (i.e. discarding all IP packets and/or PDCP PDUs associated to one specific ADU), compared to existing per-packet PDCP dropping, may lead to system capacity gain. This aspect can be implemented and may be used along with, or in parallel to, the techniques proposed in this disclosure. Aspects of the techniques for this disclosure are directed to the already scheduled packets or TBs, and addresses the PDB violation issue in the physical layer, whereas the group PDCP dropping addresses the PDB violation issue in the PDCP layer.

Aspects of the described disclosure provide and implement advanced interruption, pre-emption, and cancellation techniques for dropping application data units. For example, with respect to DL, the current DCI format 2_1 indicates in which resources the UE may assume a PDSCH is not present. The networks send a PDSCH containing DCI with DCI format 2_1 after the end of the PDSCH. However, in aspects of this disclosure, an indication can be provided to a UE to discard processing a PDSCH that is scheduled but not started, or has been started but has not yet ended. Accordingly, the network (e.g., base station, gNB) may be able to send a different packet, such as a packet corresponding to a different ADU, to the UE in the resources associated with the discarded PDSCH. Further, with respect to UL, the current DCI format 2_4 indicates in which resources the UE should cancel a PUSCH, and the UE does not expect to be re-scheduled in those resources and the HARQ buffer handling of the corresponding HARQ process follows current procedures (as in TS 38.321 clause 5.4.2 (V16.7.0)). However, in aspects of this disclosure, the network may be able to schedule another packet, such as a packet corresponding to a different ADU, in the resources associated with the discarded PUSCH and/or the HARQ buffer of the HARQ process corresponding to the to be canceled PUSCH is flushed.

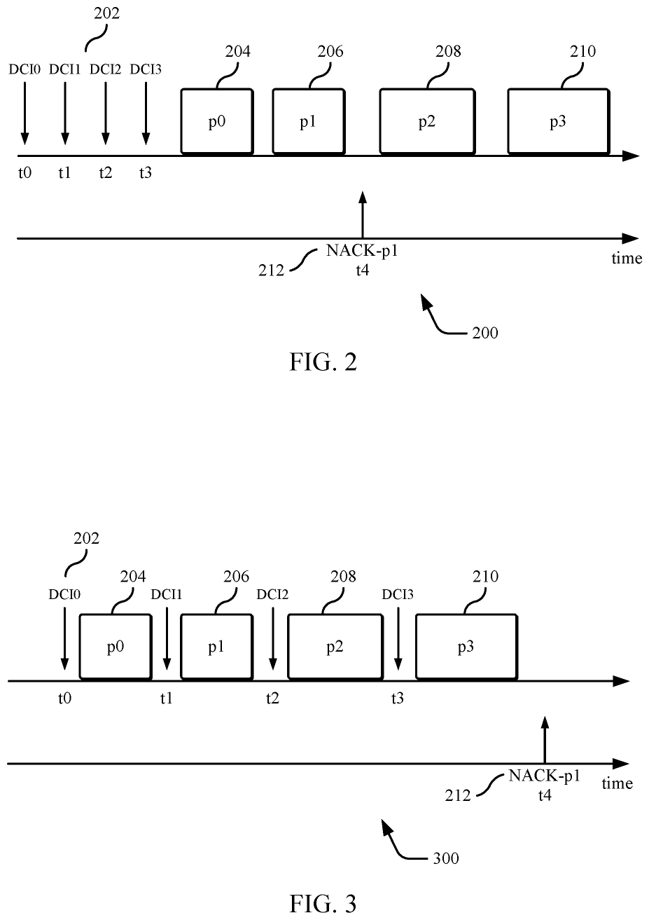

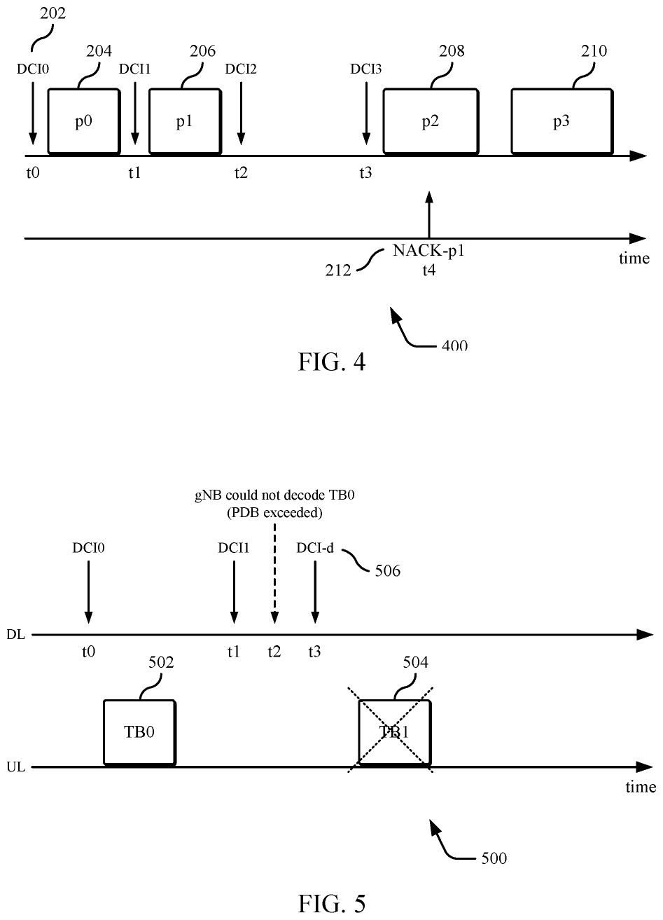

FIGS. 2, 3, and 4 illustrate example scenarios that support dropping application data units in accordance with aspects of the present disclosure, where a UE 104 receives scheduling assignments for data packets to be delivered from a base station 102 (e.g., a gNB, the ‘network’). FIG. 2 illustrates an example scenario 200 in which the UE 104 has been scheduled for four packets belonging to the same ADU, and the UE indicates a NACK in response to PDSCH reception associated with a packet 1 (‘p1’). The UE 104 receives the scheduling assignments 202 for the data packets to be delivered from the base station 102. For example, the UE 104 may receive the scheduling assignments 202 as DCI for a packet 0 (‘p0’) 204 at time ‘t0’, a packet 1 (‘p1’) 206 at time ‘t1’, a packet 2 (‘p2’) 208 at time ‘t2’, and a packet 3 (‘p3’) 210 at time ‘t3’. With respect to the timing corresponding to when the scheduling assignments 202 are received, t0<t1<t2<t3. The UE 104 communicates a NACK 212 back to the base station 102 at time ‘t4’ in response to the second scheduling assignment, which corresponds to packet 1 (‘p1’) 206, where t3<t4. FIG. 3 illustrates another example scenario 300 in which the UE 104 has been scheduled for four packets belonging to the same ADU, and the UE indicates the NACK 212 in response to PDSCH reception associated with the packet 1 (‘p1’) 206. A HARQ-ACK for packet 2 (‘p2’) 208 and packet 3 (‘p3’) 210 is scheduled to be transmitted at a time t5>t4. FIG. 4 illustrates another example scenario 400 in which the UE 104 has been scheduled for four packets belonging to the same ADU, and the UE indicates the NACK 212 in response to PDSCH reception associated with the packet 1 (‘p1’) 206.

In the example scenarios, the UE 104 can determine a set of downlink scheduled packets, such as packet 2 (‘p2’) and packet 3 ‘p3’ shown in FIG. 2, after the NACK 212 is transmitted, and the UE stops processing the determined set of scheduled packets, or discards the scheduling assignments and/or uplink grants associated with the set of scheduled packets. In alternate scenarios, the UE can determine a set of downlink scheduled packets before the NACK 212 is transmitted, or both after and before the NACK is transmitted. For instance, the UE 104 would not perform at least one of providing a hybrid automatic repeat request acknowledgement (HARQ-ACK) or transmit physical uplink control channel (PUCCH) transmissions corresponding to the set of downlink scheduled packets; decoding or error correcting downlink received transport blocks (TBs) containing the set of downlink scheduled packets; preparing and transmitting physical uplink shared channel (PUSCH) transmissions corresponding to a set of uplink scheduled packets; or hybrid automatic repeat request (HARQ) buffer handling (e.g., as per clause 5.4.2 of TS 38.321 (V16.7.0)).

In an implementation, the network (e.g., a base station, gNB) indicates to the UE via a DCI (also referred to as a discarding DCI in this disclosure) with a particular DCI format, such as a scheduling DCI with a DCI format 1-1 or 1-2 for downlink packets, or DCI format 0-1 or 0-2 for uplink packets. A group-common DCI, such as with a new DCI format or using DCI format 2_1 or 2_4, or a scheduling DCI or group-common DCI with some fields reinterpreted, can also serve the purpose of the indication to discard, stop, or not initiate processing the subset of packets. For example, a group-common DCI with a first DCI format can be used to indicate the subset of scheduled TBs to be discarded. The DCI includes up to ‘N’ TB and/or DCI discarding fields. The DCI size of the first DCI format is configurable by higher layers up to an ‘x’ number of bits.

Each discarding field may include one or more of the following: a number of scheduled TBs or DCIs from a time reference or within a time window (e.g., 2 bits), where the time reference can be determined based on the discarded DCI. For instance, the time reference can be the first symbol of a control resource set (CORESET) in which the discarded DCI format is detected; the reference time or the time window, such as a time domain resource management (TDRA)-like indication, such as the “time domain resource assignment” field in a DCI scheduling uplink or downlink transmissions, can be used to indicate the reference time or the time window; or the carrier and/or transmission-reception point (TRP) index (e.g., 2 bits).

The UE is configured with a radio network temporary identity (RNTI) (e.g., a new RNTI, discarding-RNTI, or an existing RNTI, such as INT-RNTI used for interruption indication (see TS 38.213 (V16.7.0)) or ci-RNTI (see TS 38.213 (V16.7.0)) used for cancellation indication) for monitoring PDCCH conveying the first DCI format. In an example, the component carriers (CCs) in the group-common DCI can be addressed for the UE and are configured or indicated by a MAC-CE. For instance, out of eight active CCs, a MAC-CE indication indicates a subset of four CCs, and the group-common DCI addresses each CC of the subset with an index which could be different than the component carrier index. The ‘x’ can be a predetermined value, such as ‘126’, or can be the same as other group-common DCI formats, such as DCI format 2-0, 2-1, or 2-4.

In an example, an uplink cancellation indication (ULCI with DCI format 2_4) is used to cancel scheduled uplink transmissions. The ULCI can be modified according to one or more of the following: the ULCI includes a field that indicates whether HARQ buffers associated with the transmissions to be cancelled should be flushed; the ULCI includes a field that indicates whether additional HARQ processes or scheduled TBs related (sharing the same ADU) to the ones cancelled by UCLI are to be cancelled; or the ULCI includes a field that indicates whether the UE can be scheduled for another uplink data later in the time-frequency resources indicated by the ULCI. Alternatively, the determination as to whether the UE can be scheduled for another uplink data later in the time-frequency resources as indicated by the ULCI indication can be determined from a higher layer signal, such as from a radio resource control (RRC) or MAC-CE.

In an example, a downlink interruption or pre-emption indication (DLPI with DCI format 2_1) can be used to cancel scheduled downlink transmissions, and the DLPI is modified according to one or more of the following. The DLPI includes a field that indicates whether additional HARQ processes or scheduled TBs related (sharing the same ADU) to the ones interrupted or pre-empted by DLPI are to be canceled. For example, the DLPI applies to a set of symbols, which are prior to the DLPI, whereas the additional related HARQ processes or scheduled TBs include symbols that are after the DLPI. The DLPI includes a field that indicates whether the DLPI applies to symbols prior to the DLPI or after the DLPI. If the UE detects a DCI format 2_1 for a serving cell from the configured set of serving cells, the UE may assume that no transmission to the UE is present in PRBs or in symbols that are indicated by the DCI format 2_1, and from a set of PRBs and a set of symbols of either the last monitoring period, or current or a next monitoring period according to the field. Alternatively, whether the DLPI applies to symbols prior to or after, the DLPI can be indicated by higher layer signaling such as RRC or MAC-CE. If DLPI is applicable to symbols of a current or next monitoring period, the symbols are determined based on a time gap from the DLPI, wherein the time gap can depend on a processing capability of the UE, such as PDSCH processing procedure time (e.g., defined in TS 38.214, clause 5.3 (V16.7.0), implemented with potential modifications, such as setting d1 to one (1) or d2 to zero (0) in Tproc,1 calculation and/or scaling of Tproc,1). In another example, the DLPI includes a field indicating whether the pre-emption or interruption applies to PDSCHs or PDCCHs (for DL and/or UL scheduling) or both. If the interruption applies to PDCCHs, the UE would consider the interrupted PDCCHs as discarded PDCCHs.

FIG. 5 illustrates an example 500 of gNB uplink scheduled transmissions that supports dropping application data units in accordance with aspects of the present disclosure. In this example 500, the gNB has scheduled retransmissions for UL data TB0 502 and TB1 504 at times ‘t0’ and ‘t1’, respectively. The PDB for data TB0 (after multiple repetitions) is determined at time ‘t2’ as likely to be exceeded. The gNB sends the discarding DCI (DCI-d) 506 to the UE, and the UE determines to discard data TB1 504 in response to the DCI-d. The UE then does not transmit TB1 504 and flushes the HARQ buffers associated with data TB1 and TB0.

The DCI may contain a field indicating a number of scheduled packets after the packet for which the UE has sent a negative acknowledgment in the event of downlink packet transmissions, or the gNB has sent the negative acknowledgment or scheduled a retransmission with a corresponding new data indicator (NDI) field not toggled for a corresponding HARQ process ID in the event of uplink packet transmissions. In an example, the DCI can indicate one (1) packet after the packet for which the negative acknowledgment was sent, and in this case, the UE discards packet 2 (‘p2’) 208 in the scenarios described above and illustrated in FIGS. 1, 2, and 3.

In another example, the DCI can indicate two (2) packets after the packet for which the negative acknowledgment was sent, and in this case, the UE discards packet 2 (‘p2’) 208 and packet (‘p3’) 210 in the scenarios described above and illustrated in FIGS. 1, 2, and 3. The UE may send an acknowledgment for multiple packets at the same time (e.g., for packets (‘p0’) and (‘p1’) in a HARQ-ACK codebook), and in this case, the UE determines the packets to be discarded based on the latest transmitted negative acknowledgment (that corresponds to packet (‘p1’)). The DCI may also contain a field indicating a time window, where the scheduling DCIs sent within that window should be discarded by the UE. For example, the DCI may indicate a potentially different time window corresponding to different component carriers or transmission-reception points (TRPs), or a common time window (with a reference sub-carrier spacing (SCS)) can correspond to different component carriers or TRPs. The component carrier (CC) and/or TRP indices are indicated or determined by the UE for which a time window is applicable. For example, the UE is not expected to provide a HARQ-ACK in response to the discarded downlink DCIs.

In an implementation, the UE provides a HARQ-ACK in response to a subset of the discarded downlink DCIs, where each DCI of the subset of the discarded DCIs indicates information including one or more of the following: the sCell dormancy indication, which indicates whether the active bandwidth part (BWP) of the sCell should transition to or from a dormant BWP; an active BWP change indication, which indicates a new BWP for the scheduled transmission from the BWP where the scheduling command is sent; or a minimum applicable scheduling offset indication, which is used to determine the minimum applicable K0 for the active DL BWP and the minimum applicable K2 value for the active UL BWP, if configured respectively (e.g., see Table 7.3.1.1.2-33 of TS 38.213 (V16.7.0)). If the minimum applicable K0 is indicated, the minimum applicable value of the aperiodic CSI-RS triggering offset for an active DL BWP shall be the same as the minimum applicable K0 value. For example, the UE is not expected to provide a HARQ-ACK in response to the discarded downlink DCIs if one or more of the fields sCell dormancy indication, active BWP change indication, or minimum applicable scheduling offset indication are not configured or present in the discarded downlink DCIs.

The DCI may contain a field indicating a set of HARQ process IDs, where the latest scheduling DCIs sent corresponding to the set of HARQ process IDs should be discarded by the UE. For example, a number of HARQ process IDs ‘h’ out of a maximum ‘H’ number of HARQ process IDs (‘H’ can be configured) can be indicated, where ‘h’ refers to the latest scheduled ‘h’ HARQ processes. For example, a row index from a table is indicated by the DCI, where each row of the table contains none, one, or more HARQ process IDs.

The DCI may contain a field indicating whether the subset of scheduled TBs to be discarded are for uplink, downlink, or sidelink transmissions, or a combination of thereof (e.g., both UL and DL). For example, an UL/DL DCI format differentiator (e.g., the ‘identifier for DCI formats’ bit in DCI formats 0-1/1-1) can be used. The UE uses an uplink DCI format to indicate a number of uplink scheduled TBs or DCIs to be discarded from a latest retransmission command, or from a time reference point, or corresponding to an indicated or determined time window. The UE also uses a downlink DCI format to indicate a number of downlink scheduled TBs or DCIs to be discarded from a latest retransmission command, or from a time reference point, or corresponding to an indicated or determined time window.

The DCI may contain a field indicating a set of search space indices (e.g., indicating a row index from a table, and each row of the table contains search space indices of none, or one or more search spaces), where the DCIs scheduling subset of TBs correspond to the indicated set of search spaces. For example, the UE may be indicated to discard scheduling DCIs associated with a search space index ‘A’ for a determined duration of time. The DCI may also contain a field indicating the HARQ-ACK for the subset of scheduled TBs is to be postponed, similar to the inapplicable value indication via PDSCH-to-HARQ_feedback timing indicator field for a HARQ process (e.g., as in TS 38.213 clause 9.1 (V16.7.0)), with the difference being the inapplicable value applies to all of the subset of scheduled TBs. The DCI may also contain a field indicating a PDSCH or PUSCH group index, where the PDSCHs or PUSCHs associated with an ADU has the same PDSCH or PUSCH group index and/or the PDSCHs or PUSCHs associated with the same PDSCH or PUSCH group index are to be discarded and/or the subset of scheduled TBs is determined based on the PDSCH or PUSCH group index.

The UE can indicate to the network (e.g., in a UCI), a starting index for the subset of scheduled TBs. For instance, the UE indicates from what time instance (e.g., slot number) or from which HARQ process ID, that the UE started to discard, stop, or skip processing of the scheduled TBs. In an implementation, the UE is configured with a time duration, where after receiving the discarding DCI, the UE discards the subset of scheduled TBs to be discarded within a time window of the time duration, or discards the subset of scheduled TBs which have been scheduled by DCIs to be discarded, where the DCIs are within a time window of the time duration. The beginning or end of the time window can be determined by the UE (e.g., the end of the time window could be the first symbol of the discarding DCI). The UE is not expected to receive the discarding DCI earlier than a certain time delta after one of the NACK sent in response to a PDSCH or re-transmission of a TB via a PUSCH, where the time delta can depend on a processing time (such as PDCCH processing time, PDSCH processing time, PUSCH processing time, etc.).

In an implementation, the UE receives the DCI and decreases (or does not increase) the on-time or active time duration of a discontinuous reception (DRX) cycle. For example, the value of the drx-InactivityTimer is set to zero or reduced by a determined amount if the drx-InactivityTimer has been recently restarted due to scheduling DCIs which should be discarded based on the discarding DCI indication. In another example, the drx-RetransmissionTimerDL timer or the drx-RetransmissionTimerUL timer for the HARQ process IDs associated with the set of discarded DCIs are stopped.

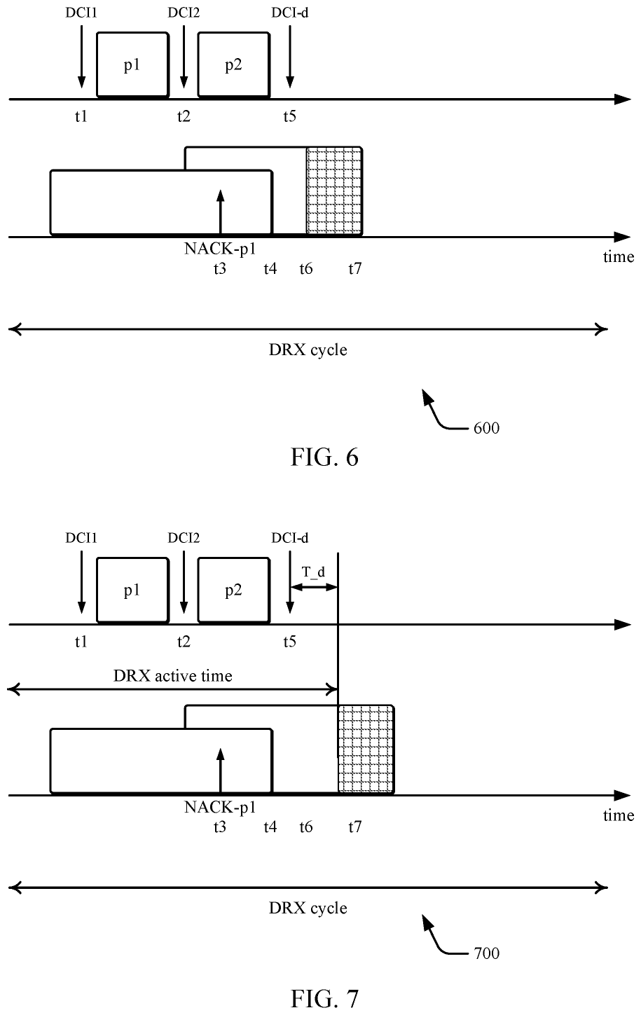

FIGS. 6 and 7 illustrate examples 600 and 700 of an extended DRX cycle during the on-duration or active time that supports dropping application data units in accordance with aspects of the present disclosure. For example, the on-duration or active time of a DRX cycle is extended from time ‘t4’ until time ‘t7’ due to a restart of the DRX-inactivity timer in response to DCI2 at time ‘t2’, when the discarding DCI (DCI-d) is sent (which commands the UE to discard DCI2), the extended on-duration is reduced to time ‘t6’ (e.g., the value of the DRX-inactivity timer is set to zero certain time ‘T_d’ after reception of DCI-d) in response to detection of the DCI-d.

In an embodiment, the network indicates, by an ADU indication in each scheduling DCI, whether the scheduled transmission is associated with the same ADU as that of a previously scheduled transmission, or as a previously sent PDSCH (which could include SPS PDSCH). Alternatively, the ADU indication indicates an ADU number associated with the scheduled transmission, and all of the scheduled transmissions with the same ADU number, within a determined window of time, correspond to the same ADU, where the number of possible ADUs is configured or specified. For example, if the UE transmits a NACK corresponding to a scheduled downlink transmission (e.g., corresponding to packet 1 (‘p1’)), then the UE would not send and is not expected to prepare or send acknowledgment for the remaining scheduled packets associated with the same ADU. In another example, if the gNB sends a NACK corresponding to an uplink scheduled transmission (e.g., corresponding to packet 1 (‘p1’)), the UE would not send and is not expected to prepare or send the remaining scheduled uplink packets associated with the same ADU.

In an example, the UE receives an indication from the network, such as a higher layer indication (e.g., radio resource control (RRC) signaling), indicating that upon determining a NACK in response to a PDSCH of an ADU, whether the UE is required or expected to provide an acknowledgement or to process the already scheduled PDSCHs of the same ADU. In an example, the UE determines a packet delay bound (PDB) associated with the ADU (or with a TB or PDU of the ADU) and upon determining the PDB cannot be met for the ADU, TB, or PDU, the UE would not send and is not expected to prepare or send an acknowledgment for the remaining scheduled packets associated with the same ADU. For example, the UE determines the PDB based on at least one of the number of retransmissions or transmitted and determined NACK feedback associated with a TB of the ADU, and whether the TB of the ADU corresponds to at least an I-frame or a P-frame of digital video.

In another example, a PDSCH may be associated with more than one ADU, in which case, the UE would not skip or stop processing that PDSCH. Alternatively, the UE processes part of the PDSCH associated with the ADU(s) that are not to be dropped. For example, the UE that is configured with a code block group (CBG) transmission, such as via a higher layer parameter codeBlockGroupTransmission (i.e., TB is partitioned into one or more CBG, and HARQ-ACK feedback as well as retransmission(s) can be performed per CBG), determines which CBGs are to be skipped or not processed, and which ones should be processed. Instead of CBG partitioning, other TB partitioning schemes can be applied, and the determination for processing or skipping the processing is based on per TB partition or based on a group of TB partitions.

In an example similar to a new data indicator (NDI) indication field that is toggled when a new TB is scheduled, the ADU indication field can be toggled if the scheduled packet is associated with or includes a new ADU. For example, a number can be configured, and upon a NACK transmission, the UE would stop processing the number of transmissions associated with the same ADU. If the UE is configured to provide soft HARQ-ACK information based on decoding a PDSCH, the UE would not prepare a soft HARQ-ACK corresponding to the discarded PDSCHs and/or PDCCHs. For example, the UE would discard all of the received PDCCHs associated with the same ADU, and at least the received PDCCHs prior to scheduling a new I-frame. The NACK corresponds to an important frame (e.g., an I-frame).

In an implementation, the UE discards the DCIs corresponding to the subset of PDSCHs. A discarded DCI reuses an uplink or downlink DCI format(s) used for scheduling PUSCH or PDSCH. The discarded DCI may contain a field distinguishing the discarded DCI from the normal DCIs scheduling PUSCH or PDSCH. Some of the DCI fields (e.g., ‘frequency domain resource assignment’) is set to a particular value, or the UE ignores those DCI fields. The gNB may provide some of the information signaled in the DCIs of the subset of packets in the discarded DCI, such as bandwidth part (BWP) change, minimum applicable scheduling offset, Scell dormancy indication, etc.

In an implementation, the UE 104 can determine to discard a set of DCIs and/or scheduled TBs, and would then perform one or more of the following operations. The UE only discards processing the code block groups (CBGs) that are not associated with an I-frame, or a slice, or a high-priority packet. The UE indicates in a UCI containing HARQ-ACK feedback whether the HARQ-ACK feedback is provided for a subset of the set of DCIs and/or scheduled TBs. The UE flushes the HARQ buffers associated with the discarded DCIs or scheduled TBs (e.g., the HARQ buffers of the associated HARQ processes). The UE does not store the MAC PDU in the associated HARQ buffer if the HARQ entity requests a new transmission for a TB that belongs to the set of scheduled TBs. The UE provides one HARQ-ACK bit for multiple HARQ processes (ACK and NACK bundling) corresponding to some of the HARQ processes corresponding to the discarded PDSCHs and PDCCHs. For example, the multiple HARQ processes are consecutive HARQ processes.

The bundled HARQ-ACK (one bit for the multiple HARQ processes) is included in a HARQ-ACK codebook that is different than the HARQ-ACK codebook containing HARQ-ACK feedback associated with each HARQ process ID. For example, a special HARQ-ACK codebook is correlated to one or more bundles of HARQ-ACK feedback provided for the subset of PDSCHs. The UE provides HARQ-ACK for each PDSCH, or for a bundle of the PDSCHs, of the subset of PDSCHs in a HARQ-ACK codebook that is associated with a PUCCH of low priority. For a first set of DCIs and/or scheduled TBs associated with the same ADU as the set of DCIs or scheduled DCIs to be discarded, or a packet for which the packet delay bound (PDB) is exceeded, the UE provides HARQ-ACK for the first set in a HARQ-ACK codebook associated with a low priority. The UE does not count in the downlink assignment indication (DAI) counting, the scheduling assignments that have been indicated or determined to be discarded, skipped, or stopped.

In an implementation, a set of HARQ process IDs corresponding to transmissions associated with the same ADU are radio resource control (RRC) configured. The set of HARQ process IDs can include a set of HARQ process IDs from a set of cells. For example, the packets and/or transmissions on a set of cells associated with the same ADU have the same HARQ process ID. Alternatively, the HARQ process ID of the packets and/or transmissions associated with an ADU on a first cell of the set of cells can be determined from the HARQ process ID of the packets or transmissions associated with the same ADU on a second cell of the set of cells. In another example, a subset of semi-persistent scheduling (SPS) configurations of a serving cell may be configured to carry data traffic associated with a same ADU during a window of time, such as a time duration of a reference periodicity (such as a periodicity determined based on a largest SPS periodicity of the subset of SPS configurations), or a least common multiplier (LCM) of the SPS periodicities of the subset of SPS configurations.

In an implementation, the UE 104 communicates uplink control information (UCI) indicating that a delay budget for a packet (to include a TB, PDU, and/or ADU) is likely to be exceeded within a probability that is not less than a configured or determined probability threshold. For example, the UCI is communicated when such an event is triggered, such as the delay budget for a packet is likely to be exceeded. The UE may use a scheduling request (SR) resource to indicate that the delay budget for the packet is likely to be exceeded, where the SR indication can include an index for the packet or for a hybrid automatic repeat request identifier (HARQ-ID) associated with the packet or an ADU index associated with the packet. In an example, a logical channel may be configured with more than one SR configurations, and one SR configuration can be used to indicate such events. The UE 104 is not expected to receive a discarding DCI before a time duration after the UCI is transmitted, where the time duration depends on one or more of a reference sub-carrier spacing (SCS) (such as the SCS associated with the PDSCH, PUCCH or PUSCH); the PDSCH processing procedure time, PUSCH preparation time, etc.; or timing advance.

In an implementation, if the UE 104 is requested to provide HARQ-ACK feedback for all the HARQ processes (e.g., via one-shot HARQ-ACK request in a DCI format (e.g., as per clause 9 of TS 38.213 (V16.7.0)), referred to as DCI-O), if DCI-O is received at least within a certain time after the discarding DCI (e.g., a time based on Tproc,1 as defined in TS 38.214 (V16.7.0)), the UE is not required to provide a HARQ-ACK corresponding to the HARQ processes associated with DCIs to be discarded in the HARQ-ACK codebook that corresponds to the HARQ-ACK request.

In the example implementations described herein, rather than stopping processing of the determined set of PDSCHs, or discarding the scheduling assignments associated with the set of PDSCHs, the priority associated with the scheduling assignments or the set of scheduled PUSCH and/or PDSCH (including the corresponding HARQ-ACK) may be changed from a high priority to a low priority. Further, rather than a NACK the UE may indicate an acknowledgment state from a set of possible acknowledgment states. For instance, the UE may indicate an ACK with a low margin with reference to a PDSCH decoding threshold, or may indicate an ACK considering an error concealment feature being used.

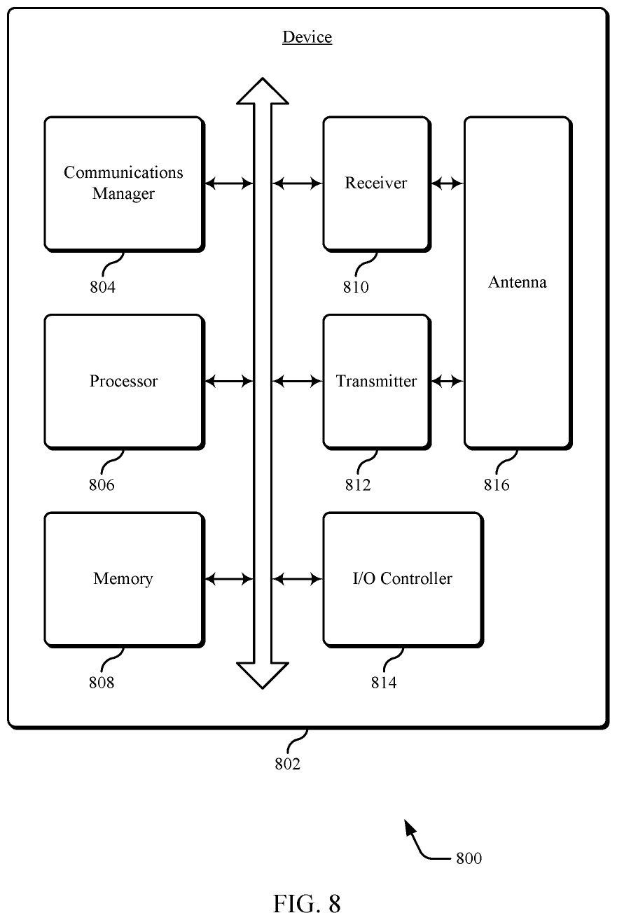

FIG. 8 illustrates an example of a block diagram 800 of a device 802 that supports dropping application data units in accordance with aspects of the present disclosure. The device 802 may be an example of a UE 104 as described herein. The device 802 may support wireless communication and/or network signaling with one or more base stations 102, other UEs 104, or any combination thereof. The device 802 may include components for bi-directional communications including components for transmitting and receiving communications, such as a communications manager 804, a processor 806, a memory 808, a receiver 810, a transmitter 812, and an I/O controller 814. These components may be in electronic communication or otherwise coupled (e.g., operatively, communicatively, functionally, electronically, electrically) via one or more interfaces (e.g., buses).

The communications manager 804, the receiver 810, the transmitter 812, or various combinations thereof or various components thereof may be examples of means for performing various aspects of the present disclosure as described herein. For example, the communications manager 804, the receiver 810, the transmitter 812, or various combinations or components thereof may support a method for performing one or more of the functions described herein.

In some implementations, the communications manager 804, the receiver 810, the transmitter 812, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 806 and the memory 808 coupled with the processor 806 may be configured to perform one or more of the functions described herein (e.g., by executing, by the processor 806, instructions stored in the memory 808).

Additionally or alternatively, in some implementations, the communications manager 804, the receiver 810, the transmitter 812, or various combinations or components thereof may be implemented in code (e.g., as communications management software or firmware) executed by the processor 806. If implemented in code executed by the processor 806, the functions of the communications manager 804, the receiver 810, the transmitter 812, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 804 may be configured to perform various operations (e.g., receiving, monitoring, transmitting) using or otherwise in cooperation with the receiver 810, the transmitter 812, or both. For example, the communications manager 804 may receive information from the receiver 810, send information to the transmitter 812, or be integrated in combination with the receiver 810, the transmitter 812, or both to receive information, transmit information, or perform various other operations as described herein. Although the communications manager 804 is illustrated as a separate component, in some implementations, one or more functions described with reference to the communications manager 804 may be supported by or performed by the processor 806, the memory 808, or any combination thereof. For example, the memory 808 may store code, which may include instructions executable by the processor 806 to cause the device 802 to perform various aspects of the present disclosure as described herein, or the processor 806 and the memory 808 may be otherwise configured to perform or support such operations.

For example, the communications manager 804 may support wireless communication and/or network signaling at a device (e.g., the device 802, a UE) in accordance with examples as disclosed herein. The communications manager 804 and/or other device components may be configured as or otherwise support an apparatus, such as a UE, including a transceiver; a processor coupled to the transceiver, the processor and the transceiver configured to cause the apparatus to: receive scheduling information for a set of physical downlink shared channel transmissions; receive downlink control information comprising an indication to discard processing of a subset of physical downlink shared channel transmissions of the set of physical downlink shared channel transmissions, the downlink control information received prior to a first physical downlink shared channel transmission of the subset of the physical downlink shared channel transmissions; and discard processing of the subset of the physical downlink shared channel transmissions based at least in part on the received downlink control information.

Additionally, the apparatus (e.g., a UE) includes any one or combination of: the processor and the transceiver are further configured to cause the apparatus to: generate a negative acknowledgment based at least in part on receiving at least a second physical downlink shared channel transmission of the set of physical downlink shared channel transmissions; and transmit the negative acknowledgment, wherein the subset of the physical downlink shared channel transmissions includes one or more physical downlink shared channels that scheduled after the at least second physical downlink shared channel. To discard the processing of the subset of the physical downlink shared channel transmissions, the processor and the transceiver are further configured to cause the apparatus to terminate hybrid automatic repeat request acknowledgement operations, or skip forward error correction operations associated with the subset of the physical downlink shared channel transmissions, or both. To discard the processing of the subset of the physical downlink shared channel transmissions, the processor and the transceiver are further configured to cause the apparatus to transmit a hybrid automatic repeat request acknowledgement associated with a physical downlink shared channel transmission of the subset of the physical downlink shared channel transmissions based at least in part on a respective downlink control information associated with the physical downlink shared channel transmission of the subset of the physical downlink shared channel transmissions, or an indication indicating whether the physical downlink shared channel of the subset of the physical downlink shared channel transmissions is associated with an intra-frame (I-frame). The processor and the transceiver are further configured to cause the apparatus to: discontinuously monitor a physical downlink control channel during an active duration for a serving cell; and reduce the active duration by a value based at least in part on the indication to discard the processing of the subset of physical downlink shared channel transmissions. The processor and the transceiver are further configured to cause the apparatus to determine the value based at least in part on a time that a hybrid automatic repeat request acknowledgement corresponding to a physical downlink shared channel of the subset of physical downlink shared channel transmissions is transmitted, or a pending duration remaining until an expiration of the active duration, or both. The processor and the transceiver are further configured to cause the apparatus to receive the downlink control information comprising the indication at or an amount of time after the hybrid automatic repeat request acknowledgement corresponding to the physical downlink shared channel transmission of the subset of physical downlink shared channel transmissions is transmitted. The subset of the physical downlink shared channel transmissions includes one or more physical downlink shared channels corresponding to packet data units of a same application data unit. The processor and the transceiver are further configured to cause the apparatus to: determine a period that a packet delay budget associated with a hybrid automatic repeat request operation exceeds a packet delay budget threshold; and transmit, to a base station, information indicating the determined period that the packet delay budget associated with the hybrid automatic repeat request operation exceeds the packet delay budget threshold. The processor and the transceiver are further configured to cause the apparatus to determine a time duration for receiving the indication to discard the processing of the subset of physical downlink shared channel transmissions, wherein to receive the downlink control information comprising the indication to discard the processing of the subset of physical downlink shared channel transmissions occurs during the time duration, the time duration occurring after the information is transmitted indicating the determined period that the packet delay budget associated with the hybrid automatic repeat request operation exceeds the packet delay budget threshold. The indication to discard the processing of the subset of physical downlink shared channel transmissions is received in a downlink control information format used for scheduling a physical uplink shared channel or a physical downlink shared channel, or both. The indication to discard the processing of the subset of physical downlink shared channel transmissions indicates a physical downlink shared channel group index, and wherein the subset of physical downlink shared channel transmissions are scheduled with the same physical downlink shared channel group index as the indicated physical downlink shared channel group index.

The communications manager 804 and/or other device components may be configured as or otherwise support a means for wireless communication and/or network signaling at a UE, including receiving scheduling information for a set of physical downlink shared channel transmissions; receiving downlink control information comprising an indication to discard processing of a subset of physical downlink shared channel transmissions, the downlink control information received prior to a first physical downlink shared channel transmission of the subset of the physical downlink shared channel transmissions; and discarding processing of the subset of the physical downlink shared channel transmissions based at least in part on the received downlink control information.

Additionally, wireless communication at the UE includes any one or combination of: generating a negative acknowledgment based at least in part on receiving at least a second physical downlink shared channel transmission of the set of physical downlink shared channel transmissions; and transmitting the negative acknowledgment, wherein the subset of the physical downlink shared channel transmissions includes one or more physical downlink shared channels that scheduled after the at least second physical downlink shared channel. The discarding processing of the subset of the physical downlink shared channels includes terminating hybrid automatic repeat request acknowledgement operations, or skipping forward error correction operations associated with the subset of the physical downlink shared channel transmissions, or both. The discarding processing of the subset of the physical downlink shared channel transmissions includes transmitting a hybrid automatic repeat request acknowledgement associated with a physical downlink shared channel transmission of the subset of the physical downlink shared channel transmissions based at least in part on a respective downlink control information associated with the physical downlink shared channel transmission of the subset of the physical downlink shared channel transmissions, or an indication indicating whether the physical downlink shared channel of the subset of the physical downlink shared channel transmissions is associated with an intra-frame (I-frame). The method further comprising: discontinuously monitoring a physical downlink control channel during an active duration for a serving cell; and reducing the active duration by a value based at least in part on the indication to discard the processing of the subset of physical downlink shared channel transmissions. The value is determined based at least in part on a time that a hybrid automatic repeat request acknowledgement corresponding to a physical downlink shared channel of the subset of physical downlink shared channel transmissions is transmitted, or a pending duration remaining until an expiration of the active duration, or both. The downlink control information comprising the indication is received at or an amount of time after the hybrid automatic repeat request acknowledgement corresponding to the physical downlink shared channel transmission of the subset of physical downlink shared channel transmissions is transmitted. The subset of the physical downlink shared channel transmissions includes one or more physical downlink shared channels corresponding to packet data units of a same application data unit. The method further comprising: determining a period that a packet delay budget associated with a hybrid automatic repeat request operation exceeds a packet delay budget threshold; and transmitting to a base station, information indicating the determined period that the packet delay budget associated with the hybrid automatic repeat request operation exceeds the packet delay budget threshold. The method further comprising: determining a time duration for receiving the indication to discard the processing of the subset of physical downlink shared channel transmissions, wherein the receiving the downlink control information comprising the indication to discard the processing of the subset of physical downlink shared channel transmissions occurs during the time duration, the time duration occurring after the information is transmitted indicating the determined period that the packet delay budget associated with the hybrid automatic repeat request operation exceeds the packet delay budget threshold. The indication to discard the processing of the subset of physical downlink shared channel transmissions is received in a downlink control information format used for scheduling a physical uplink shared channel or a physical downlink shared channel, or both. The indication to discard the processing of the subset of physical downlink shared channel transmissions indicates a physical downlink shared channel group index, and wherein the subset of physical downlink shared channel transmissions are scheduled with the same physical downlink shared channel group index as the indicated physical downlink shared channel group index.

The processor 806 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 806 may be configured to operate a memory array using a memory controller. In some other implementations, a memory controller may be integrated into the processor 806. The processor 806 may be configured to execute computer-readable instructions stored in a memory (e.g., the memory 808) to cause the device 802 to perform various functions of the present disclosure.

The memory 808 may include random access memory (RAM) and read-only memory (ROM). The memory 808 may store computer-readable, computer-executable code including instructions that, when executed by the processor 806 cause the device 802 to perform various functions described herein. The code may be stored in a non-transitory computer-readable medium such as system memory or another type of memory. In some implementations, the code may not be directly executable by the processor 806 but may cause a computer (e.g., when compiled and executed) to perform functions described herein. In some implementations, the memory 808 may include, among other things, a basic I/O system (BIOS) which may control basic hardware or software operation such as the interaction with peripheral components or devices.

The I/O controller 814 may manage input and output signals for the device 802. The I/O controller 814 may also manage peripherals not integrated into the device 802. In some implementations, the I/O controller 814 may represent a physical connection or port to an external peripheral. In some implementations, the I/O controller 814 may utilize an operating system such as iOS®, ANDROID®, MS-DOS®, MS-WINDOWS®, OS/2®, UNIX®, LINUX®, or another known operating system. In some implementations, the I/O controller 814 may be implemented as part of a processor, such as the processor 806. In some implementations, a user may interact with the device 802 via the I/O controller 814 or via hardware components controlled by the I/O controller 814.

In some implementations, the device 802 may include a single antenna 816. However, in some other implementations, the device 802 may have more than one antenna 816, which may be capable of concurrently transmitting or receiving multiple wireless transmissions. The receiver 810 and the transmitter 812 may communicate bi-directionally, via the one or more antennas 816, wired, or wireless links as described herein. For example, the receiver 810 and the transmitter 812 may represent a wireless transceiver and may communicate bi-directionally with another wireless transceiver. The transceiver may also include a modem to modulate the packets, to provide the modulated packets to one or more antennas 816 for transmission, and to demodulate packets received from the one or more antennas 816.

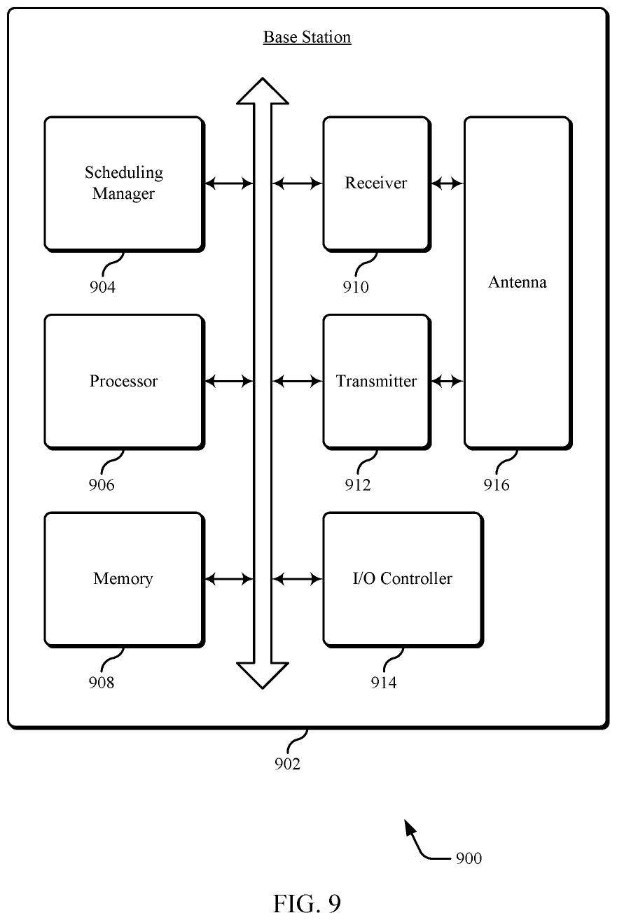

FIG. 9 illustrates an example of a block diagram 900 of a device 902 that supports dropping application data units in accordance with aspects of the present disclosure. The device 902 may be an example of a base station 102, such as a gNB as described herein. The device 902 may support wireless communication and/or network signaling with one or more base stations 102, other UEs 104, or any combination thereof. The device 902 may include components for bi-directional communications including components for transmitting and receiving communications, such as a scheduling manager 904, a processor 906, a memory 908, a receiver 910, a transmitter 912, and an I/O controller 914. These components may be in electronic communication or otherwise coupled (e.g., operatively, communicatively, functionally, electronically, electrically) via one or more interfaces (e.g., buses).

The scheduling manager 904, the receiver 910, the transmitter 912, or various combinations thereof or various components thereof may be examples of means for performing various aspects of the present disclosure as described herein. For example, the scheduling manager 904, the receiver 910, the transmitter 912, or various combinations or components thereof may support a method for performing one or more of the functions described herein.

In some implementations, the scheduling manager 904, the receiver 910, the transmitter 912, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 906 and the memory 908 coupled with the processor 906 may be configured to perform one or more of the functions described herein (e.g., by executing, by the processor 906, instructions stored in the memory 908).

Additionally or alternatively, in some implementations, the scheduling manager 904, the receiver 910, the transmitter 912, or various combinations or components thereof may be implemented in code (e.g., as communications management software or firmware) executed by the processor 906. If implemented in code executed by the processor 906, the functions of the scheduling manager 904, the receiver 910, the transmitter 912, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the scheduling manager 904 may be configured to perform various operations (e.g., receiving, monitoring, transmitting) using or otherwise in cooperation with the receiver 910, the transmitter 912, or both. For example, the scheduling manager 904 may receive information from the receiver 910, send information to the transmitter 912, or be integrated in combination with the receiver 910, the transmitter 912, or both to receive information, transmit information, or perform various other operations as described herein. Although the scheduling manager 904 is illustrated as a separate component, in some implementations, one or more functions described with reference to the scheduling manager 904 may be supported by or performed by the processor 906, the memory 908, or any combination thereof. For example, the memory 908 may store code, which may include instructions executable by the processor 906 to cause the device 902 to perform various aspects of the present disclosure as described herein, or the processor 906 and the memory 908 may be otherwise configured to perform or support such operations.

For example, the scheduling manager 904 may support wireless communication and/or network signaling at a device (e.g., the device 902, base station, gNB) in accordance with examples as disclosed herein. The scheduling manager 904 and/or other device components may be configured as or otherwise support an apparatus, such as a base station, including a transceiver; a processor coupled to the transceiver, the processor and the transceiver configured to cause the apparatus to: transmit scheduling information to a user equipment for a set of physical downlink shared channel transmissions; transmit downlink control information comprising an indication to discard processing of a subset of physical downlink shared channel transmissions of the set of physical downlink shared channel transmissions, the downlink control information received by the user equipment prior to a first physical downlink shared channel transmission of the subset of the physical downlink shared channel transmissions; and receive a negative acknowledgment from the user equipment, the negative acknowledgement received in response to the user equipment receiving at least a second physical downlink shared channel transmission of the set of physical downlink shared channel transmissions, and the subset of the physical downlink shared channel transmissions includes one or more physical downlink shared channels that scheduled after the at least second physical downlink shared channel. In an example, the second PDSCH is to be ended prior to the first PDSCH.

The scheduling manager 904 and/or other device components may be configured as or otherwise support a means for wireless communication and/or network signaling at a base station, including transmitting scheduling information to a user equipment for a set of physical downlink shared channel transmissions; transmitting downlink control information comprising an indication to discard processing of a subset of physical downlink shared channel transmissions of the set of physical downlink shared channel transmissions, the downlink control information received by the user equipment prior to a first physical downlink shared channel transmission of the subset of the physical downlink shared channel transmissions; and receiving a negative acknowledgment from the user equipment, the negative acknowledgement received in response to the user equipment receiving at least a second physical downlink shared channel transmission of the set of physical downlink shared channel transmissions, and the subset of the physical downlink shared channel transmissions includes one or more physical downlink shared channels that scheduled after the at least second physical downlink shared channel.

The processor 906 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 906 may be configured to operate a memory array using a memory controller. In some other implementations, a memory controller may be integrated into the processor 906. The processor 906 may be configured to execute computer-readable instructions stored in a memory (e.g., the memory 908) to cause the device 902 to perform various functions of the present disclosure.

The memory 908 may include random access memory (RAM) and read-only memory (ROM). The memory 908 may store computer-readable, computer-executable code including instructions that, when executed by the processor 906 cause the device 902 to perform various functions described herein. The code may be stored in a non-transitory computer-readable medium such as system memory or another type of memory. In some implementations, the code may not be directly executable by the processor 906 but may cause a computer (e.g., when compiled and executed) to perform functions described herein. In some implementations, the memory 908 may include, among other things, a basic I/O system (BIOS) which may control basic hardware or software operation such as the interaction with peripheral components or devices.

The I/O controller 914 may manage input and output signals for the device 902. The I/O controller 914 may also manage peripherals not integrated into the device 902. In some implementations, the I/O controller 914 may represent a physical connection or port to an external peripheral. In some implementations, the I/O controller 914 may utilize an operating system such as iOS®, ANDROID®, MS-DOS®, MS-WINDOWS®, OS/2®, UNIX®, LINUX®, or another known operating system. In some implementations, the I/O controller 914 may be implemented as part of a processor, such as the processor 906. In some implementations, a user may interact with the device 902 via the I/O controller 914 or via hardware components controlled by the I/O controller 914.

In some implementations, the device 902 may include a single antenna 916. However, in some other implementations, the device 902 may have more than one antenna 916, which may be capable of concurrently transmitting or receiving multiple wireless transmissions. The receiver 910 and the transmitter 912 may communicate bi-directionally, via the one or more antennas 916, wired, or wireless links as described herein. For example, the receiver 910 and the transmitter 912 may represent a wireless transceiver and may communicate bi-directionally with another wireless transceiver. The transceiver may also include a modem to modulate the packets, to provide the modulated packets to one or more antennas 916 for transmission, and to demodulate packets received from the one or more antennas 916.

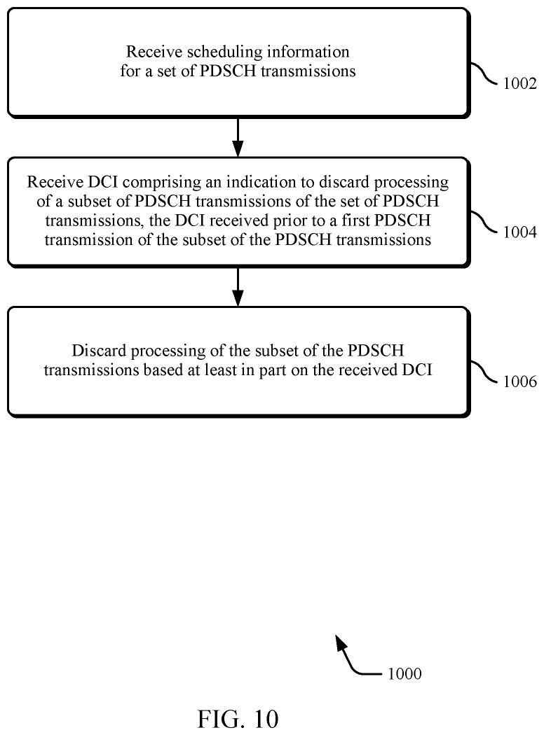

FIG. 10 illustrates a flowchart of a method 1000 that supports dropping application data units in accordance with aspects of the present disclosure. The operations of the method 1000 may be implemented by a device or its components as described herein. For example, the operations of the method 1000 may be performed by a device, such as UE 104 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1002, the method may include receiving scheduling information for a set of PDSCH transmissions. The operations of 1002 may be performed in accordance with examples as described herein. In some implementations, aspects of the operations of 1002 may be performed by a device as described with reference to FIG. 1.

At 1004, the method may include receiving DCI comprising an indication to discard processing of a subset of PDSCH transmissions of the set of PDSCH transmissions, the DCI received prior to a first PDSCH transmission of the subset of the PDSCH transmissions. In an example, the first PDSCH transmission is the earliest PDSCH transmission of the subset of PDSCH transmissions. The operations of 1004 may be performed in accordance with examples as described herein. In some implementations, aspects of the operations of 1004 may be performed by a device as described with reference to FIG. 1.

At 1006, the method may include discarding processing of the subset of the PDSCH transmissions based at least in part on the received DCI. The operations of 1006 may be performed in accordance with examples as described herein. In some implementations, aspects of the operations of 1006 may be performed by a device as described with reference to FIG. 1.

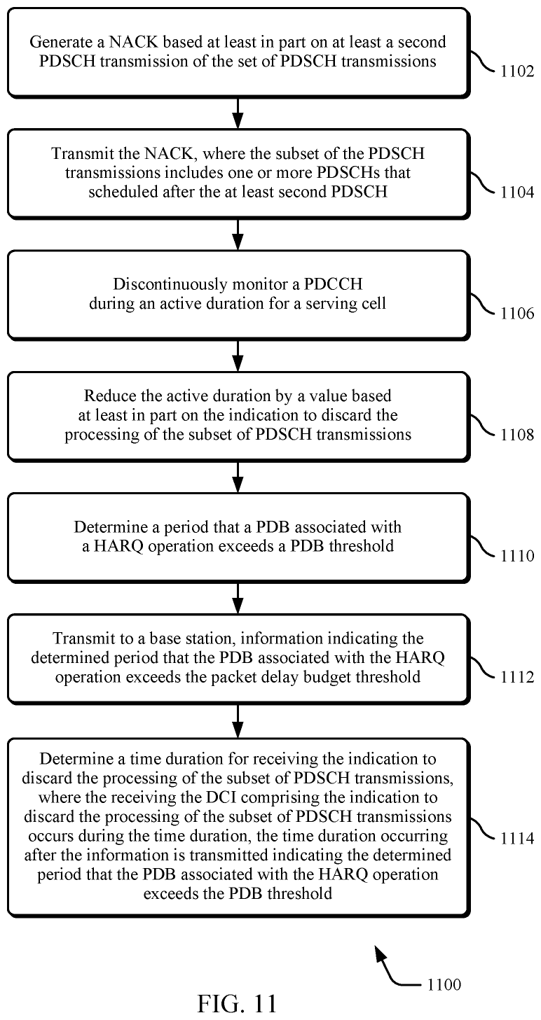

FIG. 11 illustrates a flowchart of a method 1100 that supports dropping application data units in accordance with aspects of the present disclosure. The operations of the method 1100 may be implemented by a device or its components as described herein. For example, the operations of the method 1100 may be performed by a device, such as UE 104 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1102, the method may include generating a NACK based at least in part on at least a second PDSCH transmission of the set of PDSCH transmissions. The operations of 1102 may be performed in accordance with examples as described herein. In some implementations, aspects of the operations of 1102 may be performed by a device as described with reference to FIG. 1.

At 1104, the method may include transmitting the NACK, where the subset of the PDSCH transmissions includes one or more PDSCHs that scheduled after the at least second PDSCH. The operations of 1104 may be performed in accordance with examples as described herein. In some implementations, aspects of the operations of 1104 may be performed by a device as described with reference to FIG. 1.

At 1106, the method may include discontinuously monitoring a PDCCH during an active duration for a serving cell. The operations of 1106 may be performed in accordance with examples as described herein. In some implementations, aspects of the operations of 1106 may be performed by a device as described with reference to FIG. 1.

At 1108, the method may include reducing the active duration by a value based at least in part on the indication to discard the processing of the subset of PDSCH transmissions. The operations of 1108 may be performed in accordance with examples as described herein. In some implementations, aspects of the operations of 1108 may be performed by a device as described with reference to FIG. 1.

At 1110, the method may include determining a period that a PDB associated with a HARQ operation exceeds a PDB threshold. The operations of 1110 may be performed in accordance with examples as described herein. In some implementations, aspects of the operations of 1110 may be performed by a device as described with reference to FIG. 1.

At 1112, the method may include transmitting to a base station, information indicating the determined period that the PDB associated with the HARQ operation exceeds the packet delay budget threshold. The operations of 1112 may be performed in accordance with examples as described herein. In some implementations, aspects of the operations of 1112 may be performed by a device as described with reference to FIG. 1.

At 1114, the method may include determining a time duration for receiving the indication to discard the processing of the subset of PDSCH transmissions, where the receiving the DCI comprising the indication to discard the processing of the subset of PDSCH transmissions occurs during the time duration, the time duration occurring after the information is transmitted indicating the determined period that the PDB associated with the HARQ operation exceeds the PDB threshold. The operations of 1114 may be performed in accordance with examples as described herein. In some implementations, aspects of the operations of 1114 may be performed by a device as described with reference to FIG. 1.

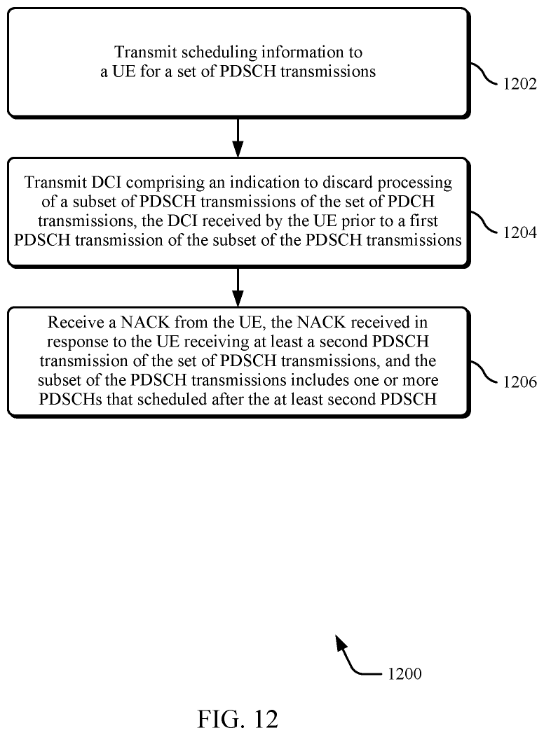

FIG. 12 illustrates a flowchart of a method 1200 that supports dropping application data units in accordance with aspects of the present disclosure. The operations of the method 1200 may be implemented by a device or its components as described herein. For example, the operations of the method 1200 may be performed by a base station 102, such as a gNB as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1202, the method may include transmitting scheduling information to a UE for a set of PDSCH transmissions. The operations of 1202 may be performed in accordance with examples as described herein. In some implementations, aspects of the operations of 1202 may be performed by a device as described with reference to FIG. 1.

At 1204, the method may include transmitting DCI comprising an indication to discard processing of a subset of PDSCH transmissions of the set of PDSCH transmissions, the DCI received by the UE prior to a first PDSCH transmission of the subset of the PDSCH transmissions. The operations of 1204 may be performed in accordance with examples as described herein. In some implementations, aspects of the operations of 1204 may be performed by a device as described with reference to FIG. 1.

At 1206, the method may include receiving a negative acknowledgment from the user equipment, the negative acknowledgement received in response to the user equipment receiving at least a second physical downlink shared channel transmission of the set of physical downlink shared channel transmissions, and the subset of the physical downlink shared channel transmissions includes one or more physical downlink shared channels that scheduled after the at least second physical downlink shared channel. The operations of 1206 may be performed in accordance with examples as described herein. In some implementations, aspects of the operations of 1206 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive scheduling information for a set of physical downlink shared channel (PDSCH) transmissions;
receive downlink control information (DCI) comprising an indication to discard processing of a subset of PDSCH transmissions of the set of PDSCH transmissions, the DCI received prior to a first PDSCH transmission of the subset of the PDSCH transmissions; and
discard the processing of the subset of PDSCH transmissions based at least in part on the received DCI.

2. The UE of claim 1, wherein the at least one processor is configured to cause the UE to:
generate a negative acknowledgment (NACK) based at least in part on receiving at least a second PDSCH transmission of the set of PDSCH transmissions; and
transmit the NACK, wherein the subset of PDSCH transmissions includes one or more PDSCHs that scheduled after the at least second PDSCH transmission.

3. The UE of claim 1, wherein, to discard the processing of the subset of PDSCH transmissions, the at least one processor is configured to cause the UE to at least one of terminate hybrid automatic repeat request acknowledgement operations, or skip forward error correction operations associated with the subset of PDSCH transmissions.

4. The UE of claim 1, wherein, to discard the processing of the subset of PDSCH transmissions, the at least one processor is configured to cause the UE to transmit a hybrid automatic repeat request acknowledgement associated with a PDSCH transmission of the subset of PDSCH transmissions based at least in part on a respective DCI associated with the PDSCH transmission of the subset of PDSCH transmissions, or an additional indication indicating whether the PDSCH of the subset of PDSCH transmissions is associated with an intra-frame (I-frame).

5. The UE of claim 1, wherein the at least one processor is configured to cause the UE to:
discontinuously monitor a physical downlink control channel (PDCCH) during an active duration for a serving cell; and
reduce the active duration by a value based at least in part on the indication to discard the processing of the subset of PDSCH transmissions.

6. The UE of claim 5, wherein the at least one processor is configured to cause the UE to determine the value based at least in part on a time that a hybrid automatic repeat request acknowledgement corresponding to a PDSCH of the subset of PDSCH transmissions is transmitted, or a pending duration remaining until an expiration of the active duration, or both.

7. The UE of claim 6, wherein the at least one processor is configured to cause the UE to receive the DCI comprising the indication at or an amount of time after the hybrid automatic repeat request acknowledgement corresponding to the PDSCH transmission of the subset of PDSCH transmissions is transmitted.

8. The UE of claim 1, wherein the subset of PDSCH transmissions includes one or more PDSCHs corresponding to packet data units (PDUs) of a same application data unit.

9. The UE of claim 1, wherein the at least one processor is configured to cause the UE to:
determine a period that a packet delay budget associated with a hybrid automatic repeat request operation exceeds a packet delay budget threshold; and
transmit, to a base station, information indicating the determined period that the packet delay budget associated with the hybrid automatic repeat request operation exceeds the packet delay budget threshold.

10. The UE of claim 9, wherein:
the at least one processor is configured to cause the UE to determine a time duration for receiving the indication to discard the processing of the subset of PDSCH transmissions; and
to receive the DCI comprising the indication to discard the processing of the subset of PDSCH transmissions occurs during the time duration, the time duration occurring after the information is transmitted indicating the determined period that the packet delay budget associated with the hybrid automatic repeat request operation exceeds the packet delay budget threshold.

11. The UE of claim 1, wherein the indication to discard the processing of the subset of PDSCH transmissions is received in a DCI format used for scheduling at least one of a physical uplink shared channel (PUSCH) or a physical downlink shared channel (PDSCH).

12. The UE of claim 1, wherein the indication to discard the processing of the subset of PDSCH transmissions indicates a PDSCH group index, and wherein the subset of PDSCH transmissions are scheduled with a same PDSCH group index as the indicated PDSCH group index.

13. A base station (BS) for wireless communication, comprising:
at least one memory; and
at least one processor coupled with the at least one memory and configured to cause the BS to:
transmit, to a user equipment (UE), scheduling information for a set of physical downlink shared channel (PDSCH) transmissions;
transmit downlink control information (DCI) comprising an indication to discard processing of a subset of PDSCH transmissions of the set of PDSCH transmissions, the DCI received by the UE prior to a first PDSCH transmission of the subset of PDSCH transmissions; and
receive, from the UE, a negative acknowledgment, the negative acknowledgement received in response to the UE receiving at least a second PDSCH transmission of the set of PDSCH transmissions, and the subset of PDSCH transmissions includes one or more PDSCHs that scheduled after the at least second PDSCH transmission.

14. A method performed by a user equipment (UE), the method comprising:
receiving scheduling information for a set of physical downlink shared channel (PDSCH) transmissions;
receiving downlink control information (DCI) comprising an indication to discard processing of a subset of PDSCH transmissions of the set of PDSCH transmissions, the DCI received prior to a first PDSCH transmission of the subset of PDSCH transmissions; and
discarding the processing of the subset of PDSCH transmissions based at least in part on the received DCI.

15. The method of claim 14, further comprising:
generating a negative acknowledgment (NACK) based at least in part on receiving at least a second PDSCH transmission of the set of PDSCH transmissions; and
transmitting the NACK, wherein the subset of PDSCH transmissions includes one or more PDSCHs that scheduled after the at least second PDSCH transmission.

16. The method of claim 14, wherein the discarding processing of the subset of PDSCH transmissions includes at least one of terminating hybrid automatic repeat request acknowledgement operations, or skipping forward error correction operations associated with the subset of PDSCH transmissions.

17. The method of claim 14, wherein the discarding processing of the subset of PDSCH transmissions includes transmitting a hybrid automatic repeat request acknowledgement associated with a PDSCH transmission of the subset of PDSCH transmissions based at least in part on a respective DCI associated with the PDSCH transmission of the subset of PDSCH transmissions, or an additional indication indicating whether the PDSCH of the subset of PDSCH transmissions is associated with an intra-frame (I-frame).

18. The method of claim 14, further comprising:
discontinuously monitoring a physical downlink control channel (PDCCH) during an active duration for a serving cell; and
reducing the active duration by a value based at least in part on the indication to discard the processing of the subset of PDSCH transmissions.

19. The method of claim 18, wherein the value is determined based at least in part on a time that a hybrid automatic repeat request acknowledgement corresponding to a PDSCH of the subset of PDSCH transmissions is transmitted, or a pending duration remaining until an expiration of the active duration, or both.

20. (canceled)

21. A processor for wireless communication, comprising:
at least one controller coupled with at least one memory and configured to cause the processor to:
receive scheduling information for a set of physical downlink shared channel (PDSCH) transmissions;
receive downlink control information (DCI) comprising an indication to discard processing of a subset of PDSCH transmissions of the set of PDSCH transmissions, the DCI received prior to a first PDSCH transmission of the subset of PDSCH transmissions; and
discard the processing of the subset of PDSCH transmissions based at least in part on the received DCI.
